(19) United States
(12) Patent Application Publication
(10) Pub. No.: US 2007/0200943 A1
(43) Pub. Date: Aug. 30, 2007

(54) Cyclic camera

(76) Inventors: Peter J. De Groot, Middletown, CT (US); Leslie L. Deck, Middletown, CT (US)

Correspondence Address: FISH & RICHARDSON PC, P.O. BOX 1022, MINNEAPOLIS, MN, 55440-1022, US

(21) Appl. No.: 11/365,752

(22) Filed: Feb. 28, 2006

(51) Int. Cl. H04N 5/335

(52) U.S. Cl. 348/294

(57) ABSTRACT

An apparatus including a camera which includes a plurality of light-sensitive pixels each capable of accumulating electronic data in response to an incident light signal. Each light-sensitive pixel is electrically coupled to two or more storage cells in the camera to define a coupled set of elements, where the elements include the light-sensitive pixel and the storage cells. Each element in each set is capable of storing electronic data related to light incident on the light-sensitive pixel. For each set of elements, the camera further includes a switch between the light sensitive pixel and at least one of the storage cells and a switch between at least one pair of the storage cells. Each switch is configured to selectively transfer electronic data between the elements connected by the switch.

### BACKGROUND

This invention relates to detectors.

In various types of optical systems, it is desirable to synchronously modulate and detect an optical image signal over a field of view. In a conventional camera, an optical signal is imaged onto an array of pixels. Charge accumulates at each pixel at a rate that depends on the intensity of the incident light. The charge value at each pixel is then read out, or transferred to a data processing unit.

The rate at which a camera can detect and read out an image is known as the frame rate. The accumulation and read out process can be slow, particularly for detectors with a large number of pixels. Conventional camera frame rates are typically limited to a few hundred Hertz for large-format (e.g., 1 Mega Pixel) cameras.

### SUMMARY

Disclosed is a cyclic camera configured to be operated as a synchronous demodulator for three or more image frames in response to a clock signal synchronized with the a modulation of the image data. For example, if the intensity of the image is modulated at 100 KHz, the clock signal can sequence the image shifts such that a full cycle occurs at the same 100 KHz rate.

Synchronous detection can be useful for reducing image noise, for example, by processing the image data so that only those intensity frequencies at the modulation rate are processed, thereby reducing, or even eliminating, intensity noise at other frequencies. For example, environmental noise typical occurs at lower frequencies.

We now summarize different aspects and features of the invention.

In general, in one aspect, the invention features an apparatus including a camera which includes a plurality of light-sensitive pixels each capable of accumulating electronic data in response to an incident light signal. Each light-sensitive pixel is electrically coupled to two or more storage cells in the camera to define a coupled set of elements, where the elements include the light-sensitive pixel and the storage cells. Each element in each set is capable of storing electronic data related to light incident on the light-sensitive pixel. For each set of elements, the camera further includes a switch between the light sensitive pixel and at least one of the storage cells and a switch between at least one pair of the storage cells. Each switch is configured to selectively transfer electronic data between the elements connected by the switch.

Embodiments may include the following features.

The electronic data can include electric charge.

One or more of the elements from the coupled set of elements can include a semiconductor device. The semiconductor device can in some embodiments, for example, include a photodiode, a charge coupled device, a MOS device, or a CMOS device.

One or more of the storage cells can be light insensitive. For example, in some embodiments, the camera can include a mask configured to block light impinging on the storage cells.

One or more switches can include a transistor switch. The transistor switch can, for example, include a CMOS device, a MOS device, or a charged coupled device.

One or more of the light sensitive pixels can include a light sensitive portion configured to accumulate electronic data in response to an incident light signal and a light insensitive portion configured to store the electronic data. In some embodiments, the light sensitive portion can be larger than the light insensitive portion. In some embodiments, the light sensitive portion may be in electrical contact with the light insensitive portion.

In some embodiments, the camera can include at least one read-out switch, wherein the read out switch is connected to an element of the coupled set of elements and wherein the read-out switch is configured to selectively transfer electronic data from the element to an external data processing unit. In some embodiments, each read-out switch is connected to a light sensitive pixel.

In some embodiments, for two or more sets of coupled elements, the light-sensitive elements can be arranged adjacently.

In some embodiments, for two or more sets of coupled elements, the light-sensitive elements can be interwoven with the storage cell elements.

In some embodiments for at least one of the sets of coupled elements, the light-sensitive pixel can have a larger area that those of the storage cells.

In general, the camera may further include a clock system configured to control the switches.

In various embodiments that clock system may include the following features.

The clock system can be configured to control the operation of the switches to perform an accumulation operation such that, for the coupled set of elements, electronic data accumulated in the light sensitive pixel is transferred to a first storage cell and the electronic data stored in the first storage cell is transferred to a second storage cell.

The clock system can be configured to control the operation of the switches to perform a read-out operation such that electronic data stored in one or more elements from a coupled set of elements is transferred to an external data processor.

In some embodiments, the clock system may be configured to perform the accumulation operation multiple times in synchrony with a modulated light signal.

In further embodiments, the clock system may be configured to perform the accumulation operation multiple times and to perform the read-out operation multiple times. For example, in some embodiments, the camera may be configured to selectively transfer electronic data between the elements of a coupled set of elements rapidly in comparison to the time required to transfer electronic data from the camera to an external data processing unit.

In some embodiments, for each coupled set of elements, there is a second switch connecting the light-sensitive pixel to another one of the storage cells for transferring charge from the other one of the storage cells to the light sensitive pixel.

In another aspect, the invention features a method including directing an optical image onto a camera which includes a plurality of light-sensitive pixels each capable of accumulating electronic data in response to the optical image, wherein each light-sensitive pixel is coupled to two or more storage cells in the camera to define a coupled set of elements, where the elements include the light-sensitive pixel and the storage cells, and each element in each set is capable of storing electronic data related to light incident on the light-sensitive pixel; for each of one or more of the sets of elements, accumulating electronic data in the light sensitive pixel for an accumulation time, transferring the electronic data accumulated in the light sensitive pixel to first additional pixel in the set, and transferring the electronic data stored in the first storage cell to a second storage cell in the set.

In some embodiments, the method may include cyclically modulating the optical image and repeating the transferring steps at rate corresponding to the cyclically modulation rate. The method may further include reading out the electronic information stored from each of elements in each set after a series of multiple cyclical modulations.

As used herein, “light” and “optical” do not only refer to visible electromagnetic radiation; rather such terms include electromagnetic radiation in any of the ultraviolet, visible, near-infrared, and infrared spectral regions.

Unless otherwise defined, all technical and scientific terms used herein have the same meaning as commonly understood by one of ordinary skill in the art to which this invention belongs. In case of conflict with any document incorporated by reference, the present disclosure controls.

Other features, objects, and advantages of the invention will be apparent from the following detailed description.

### DESCRIPTION OF DRAWINGS

FIGS. 1A through 1D are schematic diagrams showing the operation of one embodiment of a cyclic camera.

FIG. 2 is a schematic diagram of another embodiment of a cyclic camera sensor. This embodiment features three storage frames

FIG. 3 is a schematic diagram of another embodiment of a cyclic camera. This embodiment includes interwoven storage frames to shorten the distances for charge transfer between storage frames.

FIGS. 4A through 4C are schematic diagrams of another embodiment of a cyclic camera. This embodiment includes a central light sensitive pixel.

FIG. 5 is a schematic diagram of a another embodiment of a cyclic camera. This embodiment includes a large light-sensitive area surrounded by the interwoven storage cells for six storage frames.

FIG. 6 is a schematic diagram showing the operation of a typical detection system employing a cyclic camera.

FIG. 7 is a schematic diagram showing a typical application of the cyclic camera.

Like reference symbols in the various drawings indicate like elements.

### DETAILED DESCRIPTION

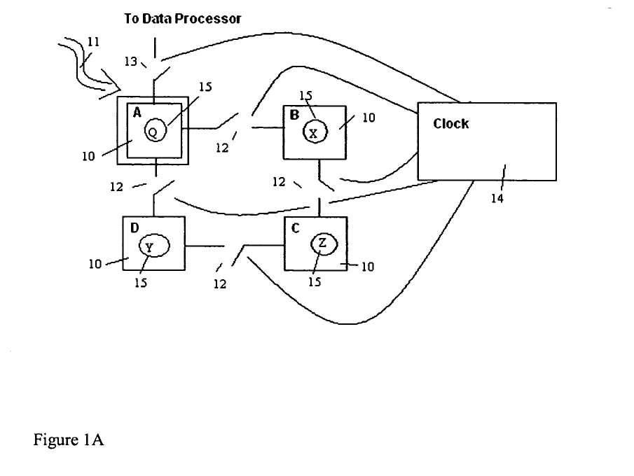

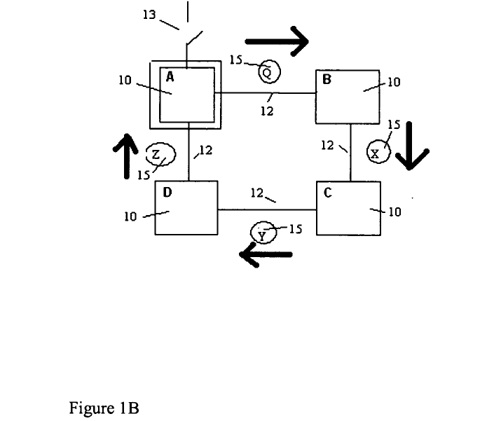

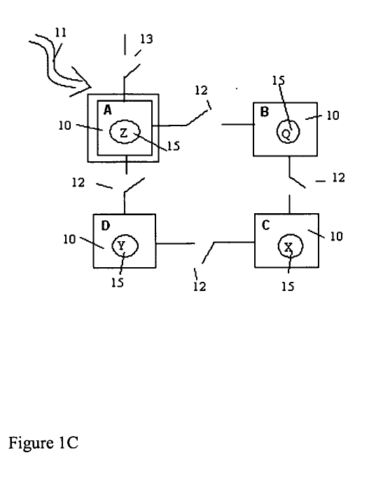

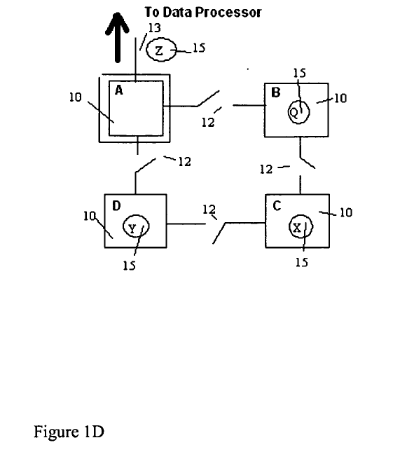

FIGS. 1A through 1D show schematic diagrams of an embodiment of a cyclic camera. A camera features one coupled set of four elements 10, labeled A, B, C, and D. In this particular embodiment, each element 10 is capable of accumulating electronic data (e.g., electric charge) in response to incident light and storing the data. The elements 10 may be designed as, for example, photodiodes, MOS capacitors with an applied bias voltage, or charge coupled devices (CCDs).

In the presently described embodiment, elements B, C, and D are covered by a mask (not shown) which blocks all incident light. Thus, only element A is light sensitive pixel element. The remaining elements B, C, and D operate as light insensitive storage cells. Accordingly, pixel element A accumulates charge when exposed to a light signal 11. The rate of charge accumulation depends on the intensity of the incident light signal 11. Switches 12 connect the elements in series, and as described in greater detail below, are configured to switch the accumulated data between different pairs of the elements. The switches 12 may be designed as transistor switches, CMOS devices, CCDs, or any other suitable switching mechanism. The switches 12 respond to a signal from a clock generator 14.

In the presently described embodiment, an additional read-out switch 13 connects pixel element A to the external data processor. The external data processor can be any device capable of reading out the electronic data stored in the pixel element. For example, the data processor can include a electronic circuit designed to amplify accumulated charge and convert it into a current or voltage signal. The clock generator is also connected to the read-out switch.

Signals from the clock generator 14 can open or close each of the switches to selectively transfer charge from one element to another and/or from pixel element A to the external data processor. For clarity, the clock unit is not shown in FIG. 1B through 1C.

Referring to FIG. 1A, initially, elements A, B, C, and D respectively store packets 15 of electronic information labeled Q, X, Y, Z. Light sensitive pixel element A is exposed to a light signal 11 and accumulates additional charge for an accumulation period, thereby building up additional charge in electronic information packet Q. During the integration time both the switches 12 connecting the elements and the read-out switch 13 remain open. Thus, charge only accumulates in the light sensitive pixel element A.

Referring to FIG. 1B, at the end of the integration time the clock unit 14 produces a signal closing the switches 12 connecting the elements. The charge stored in each frame is transferred cyclically as indicated by the black arrows. Charge flows between the elements from A to B, B to C, C to D, and D to A.

Referring to FIG. 1C, when the charge transfer is complete, the clock unit produces a signal opening the switches connecting the elements. At this point elements A, B, C, and D now contain packets 15 of electronic information Z, Q, X, and Y, respectively. Pixel element A accumulates charge for an accumulation period, thereby adding additional charge to packet of electronic information Z. At the end of the accumulation period the above process is repeated multiple times, such that each packet of electronic information receives additional charge every fourth repetition, which defines a cycle.

Referring to FIG. 1D, after multiple cycles, when sufficient charge has been accumulated such that each packet of electronic information has accumulated charge to a desired level, the clock unit 14 produces a signal which closes read-out switch 13 thereby connecting pixel element A and the data processor. Charge flows from pixel element A to the processor as shown by the black arrow. Thus, the packet of electronic information Q stored in pixel element A is read out to the processing unit. The packets of electronic information stored in the remaining elements 10 may be read out in turn by transferring the charge from one element to the next, and repeating the transfer of charge from pixel element A. As a result, the data processor receives separate signals indicative of the charge accumulated during the entire frame cycle for respective portions of the modulation cycle.

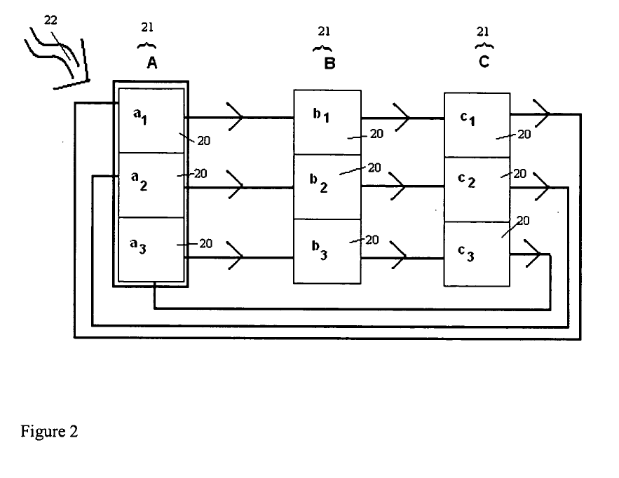

Referring to FIG. 2, an embodiment of a camera features nine elements 20 arranged into three 3×1 element storage frames 21 labeled A, B, and C. Storage frame A is composed of three light sensitive pixels elements 20 labeled a₁, a₂, and a₃. Storage frames B and C are composed of light insensitive storage cell elements labeled b₁, b₂, b₃ and c₁, c₂, c₃ respectively. The elements 20 are connected electrically to form three coupled sets. For example, light sensitive pixel a₁ is coupled to storage cells b₁ and c₁ to form a coupled set.

When a light signal is imaged onto storage frame A, each light sensitive pixel element in the frame accumulates electronic data in response to the portion of the light signal 22 incident on the pixel element 20. After an accumulation time, a clock signal (not shown) causes the transfer of electronic data between the elements 20 as shown by the bold arrows. For each set of coupled elements, electronic data stored in each element is transferred cyclically to another element. That is, data stored in element aᵢ is transferred to element bᵢ, bᵢ to cᵢ, and cᵢ to aᵢ, where i=1,2,3. Thus, the information stored in storage frame A is shifted to frame B, B to C, and C to A.

The above scheme can be simply extended to an arbitrary number of storage frames and an arbitrary number of elements in each storage frame. In certain embodiments, each storage frame may include a large number of pixel or storage cell elements (e.g., many thousands, or even millions) arranged in one, two, or three dimensions. The elements contained in each storage frame can be arranged in any suitable configuration.

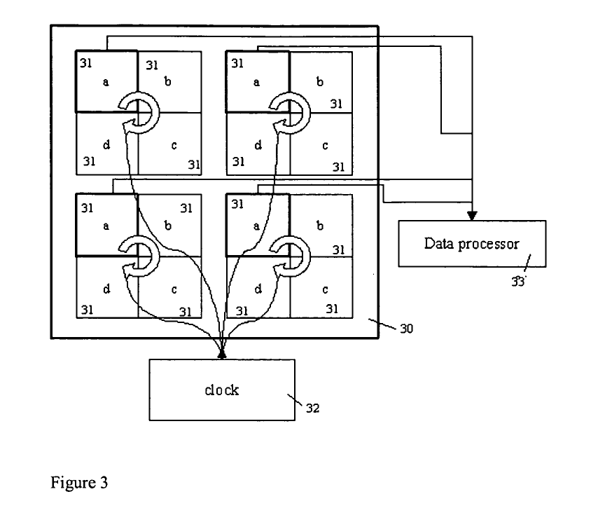

In some embodiments, the storage frames may be arranged so that elements from different storage frame are interwoven with one another. For example, referring to FIG. 3, camera 30 features four interwoven storage frames which each contain elements 31. The elements 31 labeled “a” each belong to storage frame A, those labeled “b” belong to frame B, and so forth. The elements belonging to storage frame A are light sensitive pixels. The elements belonging to storage frames B, C and D are light insensitive storage cells. Each of the elements “a” from storage frame A is located adjacent to elements “b”, “c”, and “d” belonging to frames B, C, and D respectively. Each set of adjacently located elements are electrically coupled to allow the transfer of stored information.

Also shown in FIG. 3 are connections illustrating readout and clock control of the information shifting operation. In response to a signal generated by clock 32, the charge accumulated in the elements belonging to light sensitive frame A is transferred from each pixel element “a” to the adjacent storage cell element “b”, from each storage cell element “b” to adjacent storage cell element “c” and so forth. In this way, the information stored in the storage frames is shifted from A to B, B to C, and so forth. As shown, interweaving the storage frames places coupled sets of elements in proximity to each other. Thus, this arrangement can reduce the distance over which charge transfers take place and can facilitate efficient shifting of information between the frames. In addition, the interweaving of storage frames can enable a more desired arrangement for the light-sensitive pixels. It is understood that in this simplified diagram, there are only four light sensitive pixels shown for clarity; however, in practice the camera can have many more pixels (e.g., many thousands, or even millions, or pixels), with each pixel coupled to an arbitrary number of storage cell elements.

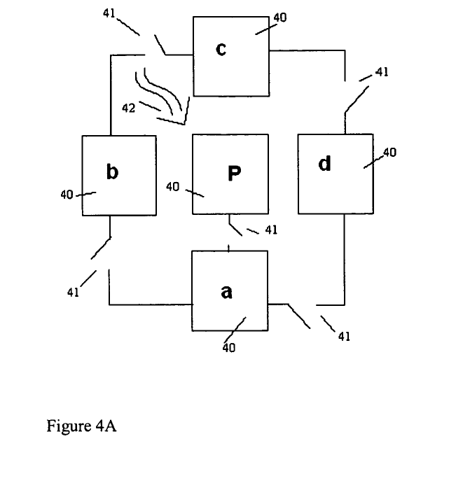

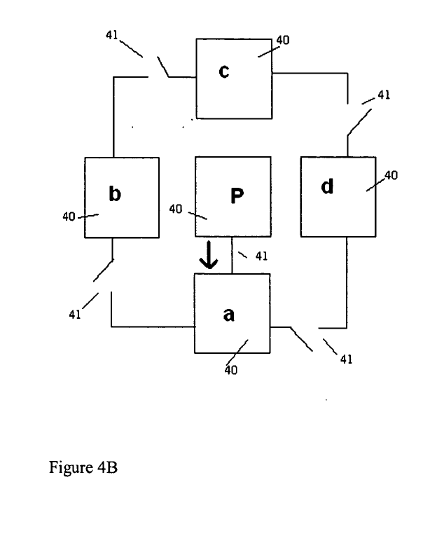

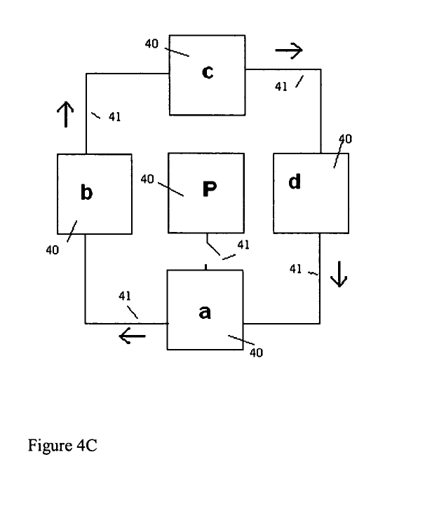

In another embodiment depicted in FIGS. 4A through 4C, a camera features one coupled set of elements 40. The set of elements 40 includes one light sensitive pixel element 40, labeled P, surrounded by four light insensitive storage cell elements 40, labeled a, b, c, and d. Each storage cell element 40 is capable of storing image information in the form of electric charge. Four switches 41 connect the storage cells in series and a fifth switch 41 connects the light sensitive pixel P to storage cell “a”. A clock system (not show) controls the operation of the switches 42 in order to selectively transfer charge between the various elements 40.

Referring to FIG. 4A, the light sensitive pixel P accumulates charge in response to an incident light signal 42 for an accumulation period. During the accumulation period all switches 41 remain open and no charge flows between the elements 40.

Referring to FIG. 4B, at the end of the accumulation period the switch 41 connecting the light sensitive pixel P to storage cell “a” is closed, and the accumulated charge is transferred to the storage cell, as illustrated by the bold arrow. The transferred charge is added to any charge previously stored in the storage cell “a”.

Referring to FIG. 4C, once the accumulated charge has been completely transferred the switch 41 connecting the light sensitive pixel P and storage cell “a” is opened while the switches 41 connecting the storage cells are closed. Charge is transferred cyclically as illustrated by the black arrows. The transfer continues until all of the charge stored in storage cell “a” has been shifted to storage cell “b”, that in “b” to “c”, and so forth.

In further embodiments, the above scheme may be modified such that a light sensitive pixel is in permanent electrical contact with a storage cell. Accumulated charge then flows continuously to the storage cell from the light sensitive pixel throughout the operation of the camera. Between accumulation periods, the charge stored in the storage cells is transferred cyclically as described above. Because the transfer process takes a short time in comparison to the accumulation period, only a small amount of charge will flow from the light sensitive pixel to the storage cell during the cyclic transfer.

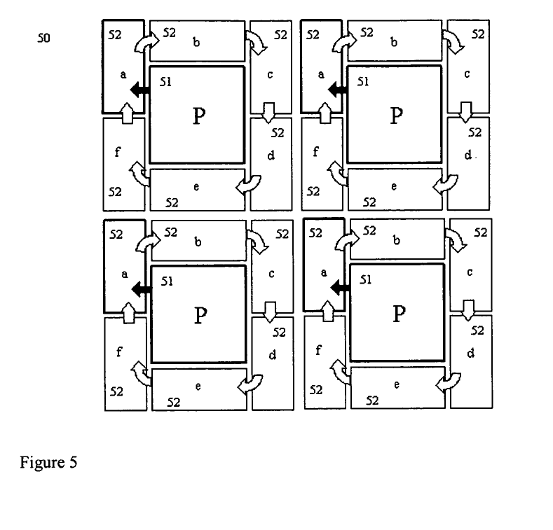

Referring to FIG. 5, a camera features six storage frames each capable of storing 4 pixels of information. The image storage frames are interwoven to allow efficient shifting of image information. In some applications it may be advantageous to increase the size of the light-sensitive elements. For this reason, large light sensitive areas 51 surrounded by smaller storage cells 52 are provided. As described above, in this specific embodiment, image information is transferred continuously from each light sensitive areas 51 to an adjacent storage cell 52 as illustrated by the black arrow. In this sense, storage cells “a” may be considered to be part of light sensitive pixels “P”, respectively. Between accumulation periods image information is shifted between the storage cells 52 as illustrated by the grey arrows.

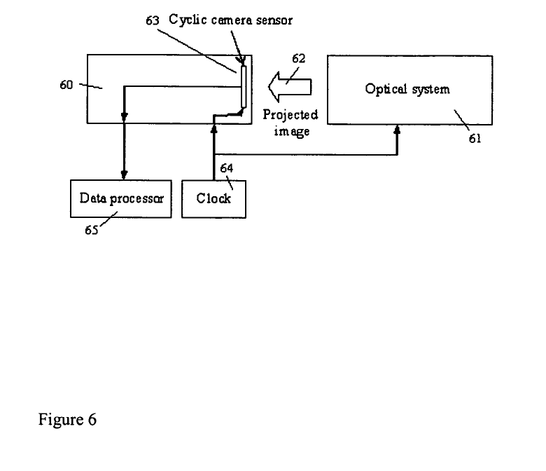

Referring to FIG. 6, a typical application of the cyclic camera 60 in a measurement system is shown. An optical system 61 projects a modulated light signal 62 onto cyclic camera sensor 63. The modulated light signal 62 may, for example, be composed of images that repeat cyclically (although any suitable modulated signal may be used). These repeated images correspond to image modulations governed by clock signal 64 provided by clock 65. The cyclic camera 60 captures the repeated images to build up electronic images that can be transmitted to a data processor 66 after a given number of acquisition cycles.

The cyclic camera 60 can be operated as a synchronous demodulator by providing the camera with a clock signal 64 synchronized with the modulation of the image data. For example, if the intensity of the image is modulated at 100 kHz, the clock can sequence the image shifts such that a full acquisition cycle occurs at the same 100 kHz rate. In various embodiments optical system 61 may be, for example, a range-sensing device using intensity modulation, a polarization analyzer, or any image with noise that would benefit from lock-in detection. More generally, optical system 61 can modulate any aspect (e.g., intensity, phase, and/or polarization, etc.) of the images in a cyclical manner.

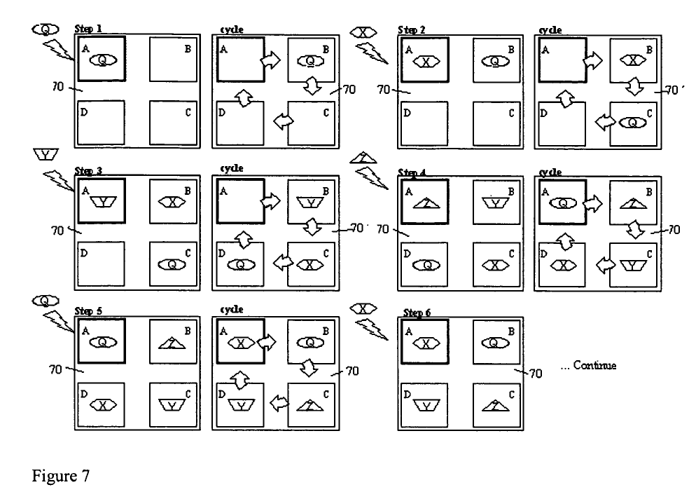

FIG. 7. illustrates the functioning of an embodiment of the cyclic camera in a single figure. A cyclic camera 70 features four storage frames, labeled A, B, C, D. The frames each may be a two-dimensional array of elements, located either on separate portions of a sensor, interwoven as described above, or arranged in any other way that is convenient and efficient. Storage frame A is light sensitive and accumulates charge when exposed to a projected image. Initially, there is no image information in any of the storage frames. In step 1, the camera is exposed to an image Q, which is recorded in frame A. At the end of an integration time, a first clock signal causes all of the image information to be rapidly shifted from each image frame to the next image frame. The shifting process may, for example, be accomplish by any of the schemes described above. Image information stored in frame A is shifted to frame B, B to C, C to D, and D to A. After the image shift, in step 2, the camera 70 is exposed to an image X, and the image information is again collected in frame A for an integration time. A second clock signal then causes the image information to rapidly shift cyclically from frame A to frame B and so forth once again. In steps three and four, the camera 70 is exposed to image Y and Z in the same manner, so that one image is stored in each of the storage frames. In step 5, the image Q is again projected onto the camera, causing the stored image Q to be reinforced. The cyclic image shifting continues in this way, with the projection of images synchronized so as to reinforce the image strength in each of the storage frames 71. The cycling through of images continues until a total integration time is reached, at which point the stored image information may be read out. In an preferred embodiment, the image storage frames 71 are only connected to each other during the image shifting cycle, not during image acquisition. During image acquisition, the conversion of light energy to electrical information takes place only for the image storage frame A that is sensitive to light.

One method of reading out the information is to cycle through the images in the same way as during image acquisition, but rather than accumulating image information in frame A by exposure to light, extract image information from A electronically and transfer it to a data processing unit. The information transfer continues through each clock cycle until all of the image information has been read out from all of the image storage frames.

In any of the embodiments described above, the clock generator and data processor can be configured as part of a digital computer and/or dedicated preprogrammed integrated circuits.

As described above, in certain embodiments, one or more of the storage cell elements are light sensitive pixels made light-insensitive by using a physical mask to block incident light. In other embodiments, the storage cell elements can be electronically configured to store and transfer charge, without having a photosensitive response to incident light.

Although the embodiments of the camera have been described above with elements accumulating or storing electronic information as charge, in other embodiments the elements may accumulate or store the information in a different form, such as potential difference.

Although the camera has been described for use with optical images, the cyclic camera, including the arrangement of three or more storage frames in the camera, can also be configured for other types of incident images.

A number of embodiments of the invention have been described. Nevertheless, it will be understood that various modifications may be made without departing from the spirit and scope of the invention. For example, although a number of pixel, storage cell, and image frame arrangements have been shown, it will be understood that any suitable spatial arrangement and number of pixels and storage cells may be used. Accordingly, other embodiments are within the scope of the following claims.

What is claimed is:

1. Apparatus comprising:
a camera comprising a plurality of light-sensitive pixels each capable of accumulating electronic data in response to an incident light signal, wherein each light-sensitive pixel is electrically coupled to two or more storage cells in the camera to define a coupled set of elements, the elements comprising the light-sensitive pixel and the storage cells, and wherein each element in each set is capable of storing electronic data related to light incident on the light-sensitive pixel,
for each set of elements, the camera further comprises a switch between the light sensitive pixel and at least one of the storage cells and a switch between at least one pair of the storage cells, wherein each switch is configured to selectively transfer electronic data between the elements connected by the switch.

2. The apparatus of claim 1, wherein the electronic data comprises electric charge.

3. The apparatus of claim 1, wherein one or more of the elements from the coupled set of elements comprise a semiconductor device.

4. The apparatus of claim 3, wherein the semiconductor device comprises a photodiode, a charge coupled device, a MOS device, or a CMOS device.

5. The apparatus of claim 1, wherein one or more of the storage cells is light insensitive.

6. The apparatus of claim 5, wherein the camera further comprises a mask configured to block light impinging on the storage cells.

7. The apparatus of claim 1, wherein one or more switches comprise a transistor switch.

8. The apparatus of claim 7, wherein the transistor switch comprises a CMOS device, a MOS device, or a charged coupled device.

9. The apparatus of claim 1, wherein one or more of the light sensitive pixels comprise a light sensitive portion configured to accumulate electronic data in response to an incident light signal and a light insensitive portion configured to store the electronic data.

10. The apparatus of claim 9, wherein the light sensitive portion is larger than the light insensitive portion.

11. The apparatus of claim 9, wherein the light sensitive portion is in electrical contact with the light insensitive portion.

12. The apparatus of claim 1, further comprising at least one read-out switch, wherein the read out switch is connected to an element of the coupled set of elements and wherein the read-out switch is configured to selectively transfer electronic data from the element to an external data processing unit.

13. The apparatus of claim 12, wherein each read-out switch is connected to a light sensitive pixel.

14. The apparatus of claim 1, wherein, for two or more sets of coupled elements, the light-sensitive elements are arranged adjacently.

15. The apparatus of claim 1, wherein, for two or more sets of coupled elements, the light-sensitive elements are interwoven with the storage elements.

16. The apparatus of claim 1, wherein for at least one of the sets of coupled elements, the light-sensitive pixel has a larger area that those of the storage cells.

17. The apparatus of claim 1, further comprising a clock system configured to control the switches.

18. The apparatus of claim 17, wherein the clock system is configured to control the operation of the switches to perform an accumulation operation such that, for the coupled set of elements, electronic data accumulated in the light sensitive pixel is transferred to a first storage cell and the electronic data stored in the first storage cell is transferred to a second storage cell.

19. The apparatus of claim 18, wherein the clock system is further configured to control the operation of the switches to perform a read-out operation such that electronic data stored in one or more elements from a coupled set of elements is transferred to an external data processor.

20. The apparatus of claim 18, wherein the clock system is configured to perform the accumulation operation multiple times in synchrony with a modulated light signal.

21. The apparatus of claim 20, wherein the clock system is configured to perform the accumulation operation multiple times and to perform the read-out operation multiple times.

22. The apparatus of claim 21, wherein the camera is configured to selectively transfer electronic data between the elements of a coupled set of elements rapidly in comparison to the time required to transfer electronic data from the camera to an external data processing unit.

23. The apparatus of claim 1, wherein for each coupled set of elements, there is a second switch connecting the light-sensitive pixel to another one of the storage cells for transferring charge from the other one of the storage cells to the light sensitive pixel.

24. A method comprising:
directing an optical image onto a camera comprising a plurality of light-sensitive pixels each capable of accumulating electronic data in response to the optical image, wherein each light-sensitive pixel is coupled to two or more storage cells in the camera to define a coupled set of elements, the elements comprising the light-sensitive pixel and the storage cells, and each element in each set is capable of storing electronic data related to light incident on the light-sensitive pixel;
for each of one or more of the sets of elements, accumulating electronic data in the light sensitive pixel for an accumulation time, transferring the electronic data accumulated in the light sensitive pixel to first additional pixel in the set, and transferring the electronic data stored in the first storage cell to a second storage cell in the set.

25. The method of claim 24, further comprising cyclically modulating the optical image and repeating the transferring steps at rate corresponding to the cyclically modulation rate.

26. The method of claim 25, further comprising reading out the electronic information stored from each of elements in each set after a series of multiple cyclical modulations.
